(19) United States
(12) Patent Application Publication
(10) Pub. No.: US 2014/0350813 A1
(43) Pub. Date: Nov. 27, 2014

(54) APPARATUS AND METHOD FOR PREVENTING COLLISION WITH VEHICLE

(71) Applicant: Hyundai Motor Company, Seoul (KR)

(72) Inventors: Dae S. Jeon, Gyeonggi-do (KR); Suk K. Min, Gyeonggi-do (KR)

(73) Assignee: HYUNDAI MOTOR COMPANY, Seoul (KR)

(21) Appl. No.: 14/097,359

(22) Filed: Dec. 5, 2013

(30) Foreign Application Priority Data
May 21, 2013 (KR) 10-2013-0056969

(51) Int. Cl. G08G 1/16

(52) U.S. Cl. CPC G08G 1/166
USPC 701/70

(57) ABSTRACT

An apparatus and a method for preventing collision with a vehicle are provided. The apparatus and method are capable of preventing collision with a front vehicle and a rear-side vehicle by braking a traveling vehicle in a braking avoidance section when there is a possibility of a collision. In addition, a vehicle steering right is imposed to a driver in a steering avoidance section when there is no the possibility of a collision, based on collision with a rear-side vehicle according to steering in a steering avoidance section, which is predicted in a braking avoidance section.

### CROSS-REFERENCE TO RELATED APPLICATION

This application is based on and claims priority from Korean Patent Application No. 10-2013-0056969, filed on May 21, 2013 in the Korean Intellectual Property Office, the disclosure of which is incorporated herein in its entirety by reference.

### BACKGROUND

1. Field of the Invention

The present invention relates to an apparatus and a method for preventing collision with a vehicle, and more particularly, to a technology that prevents a collision with a front vehicle and a rear-side vehicle, based on a collision with a rear-side vehicle according to steering in a steering avoidance section, which is predicted in a braking avoidance section.

In the present invention the steering avoidance section means a section for preventing a traveling vehicle from colliding with the front vehicle through steering and the braking avoidance section means a section for preventing a traveling vehicle from colliding with the front vehicle by braking. Further, when the traveling vehicle passes through the steering avoidance section directly to the braking avoidance section, the traveling Vehicle collides with the front vehicle, independent of the braking and the steering.

2. Description of the Prior Art

In general, an apparatus for preventing collision with a vehicle is configured to calculate a steering avoidance section based on a relative velocity to a front vehicle, lateral acceleration, a quantity overlapping with a front vehicle, a coefficient of friction, acceleration of gravity, and the like and is then configured to output an alarm when a traveling vehicle enters a steering avoidance section to allow a driver to change a lane. In particular, the quantity overlapping with the front vehicle means a quantity covering the front vehicle based on a width of the traveling vehicle. In other words, when the front vehicle and the traveling vehicle are disposed on a straight line in a driving direction, the front vehicle and the traveling vehicle completely overlap with each other.

The apparatus for preventing collision with a vehicle according to the related art may cause a collision with a rear-side vehicle during a process of changing a lane since the traveling vehicle enters the steering avoidance section and then outputs an alarm. In this case, even though a vehicle may not be present in the rear side, it may be safer for a driver to brake within a safe distance from the front vehicle rather than steering in an urgent situation.

### SUMMARY

Accordingly, the present invention provides an apparatus and a method for preventing collision with a vehicle that prevents a collision with a front vehicle and a rear-side vehicle by braking a vehicle in a braking avoidance section when there is a possibility of a collision and imposing a steering right on a driver in a steering avoidance section when there is no (e.g., a minimal) possibility of a collision, based on collision with a rear-side vehicle according to steering in a steering avoidance section, which may be predicted in a braking avoidance section.

In one aspect of the present invention, an apparatus that prevents a collision with a vehicle may include a plurality of units executed by a controller having a processor and a memory. The plurality of units may include an information collection unit configured to collect information required to calculate time-to-collision (TTC), a braking avoidance section, and a steering avoidance section; a braking avoidance section calculation unit configured to calculate the braking avoidance section in which the collision with a front vehicle is avoided by braking; a steering avoidance section calculation unit configured to calculate the steering avoidance section in which the collision with a front vehicle is avoided by steering; and a braking unit configured to brake a vehicle based on the braking signal. The controller (e.g., control unit) may also be configured to calculate ITC with a rear-side vehicle when the traveling vehicle enters the braking avoidance section and generate a braking signal when the calculated TTC satisfies a threshold value.

In another aspect of the present invention, a method for preventing collision with a vehicle may include: collecting, by an information collection unit, information required to calculate time-to-collision (TTC), a braking avoidance section, and a steering avoidance section; calculating, by a braking avoidance section calculation unit, the braking avoidance section in which the collision with a front vehicle is avoided by braking; a steering avoidance section calculation unit, the steering avoidance section in which the collision with a front vehicle is avoided by steering; calculating TTC with a rear-side vehicle when the traveling vehicle enters the braking avoidance section and generating a braking signal when the calculated TTC satisfies a threshold value, by the control unit; and braking by a braking unit, a vehicle based on the braking signal.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram of an apparatus that prevents a collision with a vehicle according to an exemplary embodiment of the present invention;

FIG. 2 is an exemplary diagram illustrating an example of the relationship between a braking avoidance section and a steering avoidance section according to the exemplary embodiment of the present invention; and

FIG. 3 is an exemplary flow chart of a method for preventing collision with a vehicle according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include., but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will he further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings.

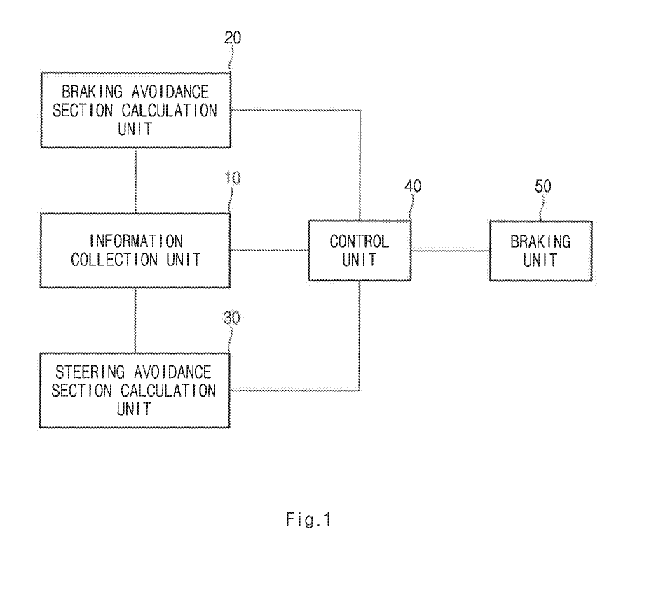

FIG. 1 is an exemplary diagram of an apparatus that prevents a collision with a vehicle according to an exemplary embodiment of the present invention. As shown in FIG. 1, an apparatus that prevents a collision with a vehicle may include a plurality of units executed by a control unit 40. The plurality of units may include an information collection unit 10, a braking avoidance section calculation unit 20, a steering avoidance section calculation unit 30, and a braking unit 50.

Describing each component, the information collection unit 10, executed by the control unit 40, may be configured to collect information required to calculate a braking avoidance section, information required to calculate a steering avoidance section, information required to calculate time-to-collision (TTC) which is a value obtained by dividing a distance between a traveling vehicle and a rear-side vehicle by a relative velocity, and the like, via a vehicle communication network. In particular, the vehicle communication network may be connected to various types of sensors that measure the above-mentioned information and may include at least one of a controller area network (CAN), a local interconnect network (LIN), FlexRay, and media oriented system transport (MOST).

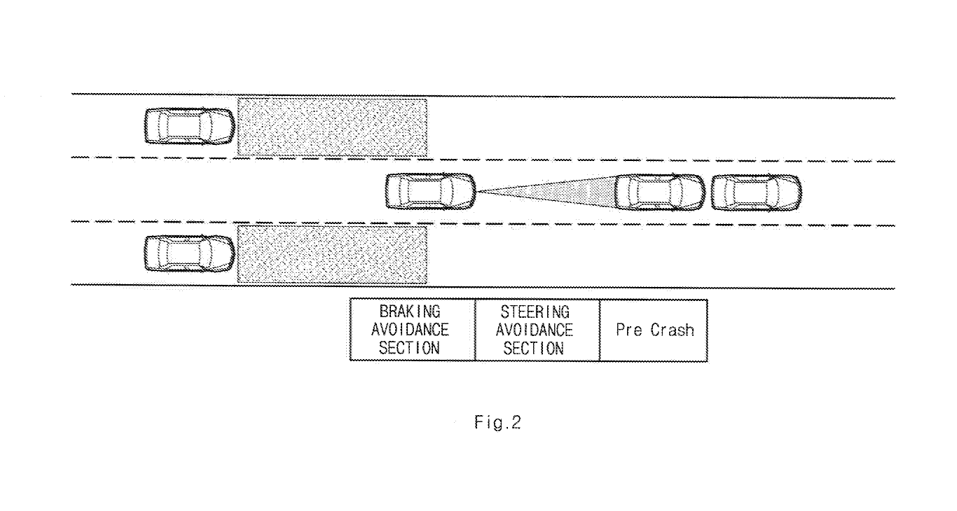

Herein, a positional relationship between the above-mentioned braking avoidance section and steering avoidance section is illustrated in FIG. 2.

Further, the information collection unit 10 may be configured to collect width information of the traveling vehicle. The information required to calculate the braking avoidance section may include a relative velocity to a front vehicle (e.g., a vehicle disposed ahead of the traveling vehicle), longitudinal acceleration, a coefficient of friction, acceleration of gravity, and the like. Herein, the coefficient of friction generally means a coefficient of friction (constant) on a paved road.

In addition, the information required to calculate the steering avoidance section may include a relative velocity to a front vehicle, lateral acceleration, a quantity overlapping with a front vehicle, a coefficient of friction, acceleration of gravity, and the like. The quantity overlapping with the front vehicle means a quantity that covers the front vehicle based on a width of the traveling vehicle. In other words, when the front vehicle and the traveling vehicle are disposed on a straight line in a driving direction, the front vehicle and the traveling vehicle completely overlap with each other.

The information required to calculate the TTC may include a distance from a rear-side vehicle, a relative velocity to a rear-side vehicle, a distance from a front vehicle, a relative velocity to a front vehicle, and the like. In other words, the TTC with the rear-side vehicle may be calculated using the distance from the rear-side vehicle and the relative velocity to the rear-side vehicle and the TTC with the front vehicle may be calculated using the distance from the front vehicle and the relative velocity to the front vehicle.

Moreover, the braking avoidance section calculation unit 20, executed by the control unit 40, may be configured to calculate a threshold braking time t_{LPB} and a threshold braking distance d_{brake} using the Equation 1 below.

$${t}_{LPB} = \frac{{d}_{brake}}{- {v}_{rel}} = - \frac{{v}_{rel}}{2 μg} , \\ {d}_{brake} = - \frac{{v}_{rel}^{2}}{2 {a}_{x}} \qquad Equation 1$$

In the above Equation 1, vᵣₑₗ represents the relative velocity to the front vehicle, aₓ represents the longitudinal velocity, μ represents the coefficient of friction, and g represents the acceleration of gravity.

Thereafter, the braking avoidance section calculation unit 20 may be configured to calculate the braking avoidance section by adding a buffer distance (e.g., a constant) to the calculated threshold braking distance d_{brake}. For example, when the threshold braking distance is about 100 m, the braking avoidance section may range from about 120 m to 100 m. In other words, a separation distance from the front vehicle which ranges from a point of about 120 in to a point of about 100 in may become the braking avoidance section. In this case, the buffer distance may be changed according to a designer's intention.

Furthermore, the steering avoidance section calculation unit 30, executed by the control unit 40, may be configured to calculate a threshold steering time t_{LPS} and a threshold steering distance dₛₜₑₑᵣ, based on the following Equation 2.

$${t}_{LPS} = \frac{{d}_{steer}}{- {v}_{rel}} = \sqrt{\frac{2 {s}_{v}}{μg}} , \\ {d}_{steer} = - {v}_{rel} \sqrt{\frac{2 {s}_{v}}{{a}_{v}}} \qquad Equation 2$$

In the above Equation 2, s_{y} represents a quantity overlapping with a front vehicle (e.g., a width of a traveling vehicle covered by a front vehicle), a_{y} represents lateral acceleration, μ represents a coefficient of friction, and g represents acceleration of gravity, In particular, when a width of a traveling vehicle is about 1.8 m and the traveling vehicle overlaps with the front vehicle by about 50%, s_{y} becomes about 0.9 and when the traveling vehicle overlaps with the front vehicle by about 100%, s_{y} becomes about 1.8. s_{y} may be obtained by, for example, an imaging device (e.g., a camera) and a laser scanner,

Thereafter, the steering avoidance section calculation unit 30 may be configured to calculate the braking avoidance section by adding the buffer distance to the calculated threshold steering distance dₛₜₑₑᵣ. For example, when the threshold steering distance is about 30 m, the steering avoidance section may range from about 50 m to about 30 m. In other words, the separation distance from the front vehicle which ranges from a point of about 50 m to a point of about 30 m may become the steering avoidance section. In this case, the buffer distance may be changed according to a designer's intention.

Additionally, when the traveling vehicle enters the braking avoidance section, the control unit 40 may be configured to calculate the TTC with the rear-side vehicle when the calculated TTC satisfies a threshold value (e.g., about 1.5 seconds), predict that collision occurs in the steering avoidance section to transmit the braking signal to the braking unit 50. In other words, when the TTC with the rear-side vehicle satisfies the threshold value in the braking avoidance section, the control unit 40 may be configured to determine that the collision with the rear-side vehicle occurs when the traveling vehicle is steered in the steering avoidance section to previously brake a vehicle in the braking avoidance section before the traveling vehicle enters the steering avoidance section. By doing so, even when a vehicle is present at rear-side in the steering avoidance section which may not prevent the collision by braking, it may be possible to prevent the collision between the front vehicle and the rear-side vehicle.

Herein, as described above, the control unit 40 may be configured to generate the braking signal when both a rear-left vehicle and a rear-right vehicle are present and may be configured to generate the braking signal for driver safety even when only one of the rear-left vehicle and the rear-right vehicle is present. Further, when only one of the rear-left vehicle and the rear-right vehicle is present, the control unit may be configured to not generate the braking signal. In this case, a driver may be informed of the lane in which the rear-side vehicle is not present, such that the driver may steer a vehicle toward a lane in which the rear-side vehicle is not present in the steering avoidance section.

Meanwhile, the control unit 40 may be configured to calculate the TTC with the rear-side vehicle before a vehicle enters the braking avoidance section to monitor the rear-side vehicle. Further, the control unit 40 may be configured to impose a vehicle steering right to a driver in the steering avoidance section when the rear-side vehicle is not present. Next, the braking unit 50, executed by the control unit 40, may be configured to brake the vehicle based on the braking signal generated from the control unit 40.

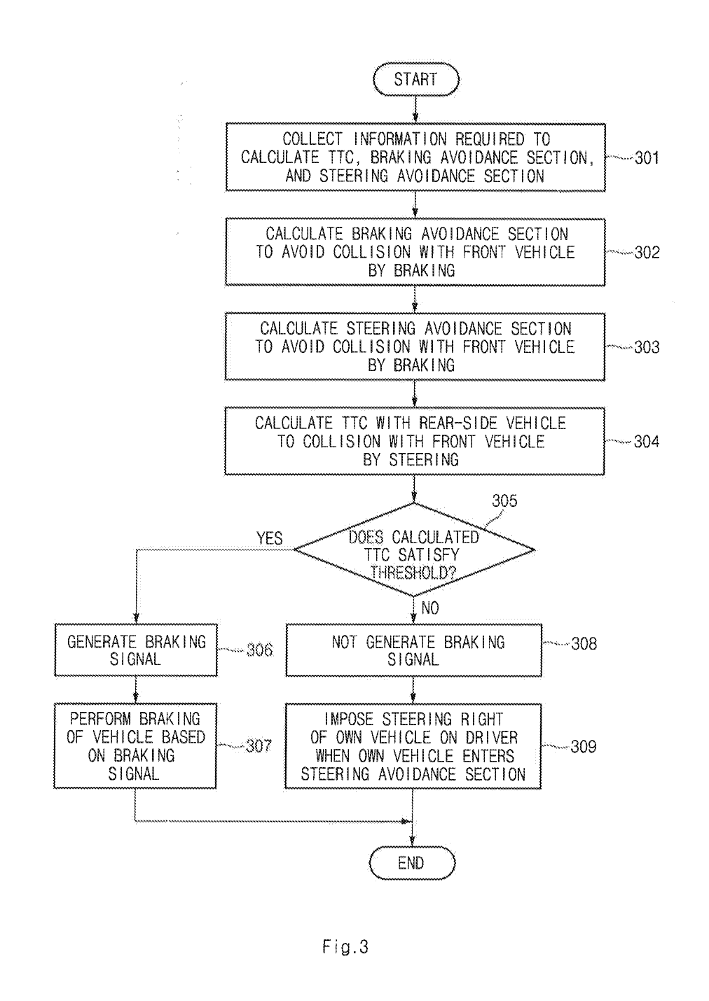

FIG. 3 is an exemplary flow chart of a method fix preventing collision with a vehicle according to the exemplary embodiment of the present invention.

First, the information collection unit 10 may be configured to collect the information required to calculate the time-to-collision (TTC), the braking avoidance section, and the steering avoidance section (301). The braking avoidance section calculation unit 20 may be configured to calculate the braking avoidance section which may avoid the collision with the front vehicle by the braking (302). Further, the braking avoidance section calculation unit 30 may be configured to calculate the steering avoidance section which may avoid the collision with the front vehicle by steering (303).

When a traveling vehicle enters the braking avoidance section, the control unit 40 may be configured to calculate the TTC with the rear-side vehicle (304). Next, whether the calculated TTC satisfies the threshold value (305) may be determined. As the confirmation result (305), when the TTC C satisfies the threshold value, the braking signal may be generated (306). Additionally, the braking unit 50 may be configured to brake a vehicle based on the braking signal (307). As the confirmation result (305), when the TTC does not satisfy the threshold value, the braking signal may not be generated (308). Further, when the traveling vehicle enters the steering avoidance section, the control unit 40 may be configured to impose the vehicle steering right to a driver (309).

As set forth above, according to the exemplary embodiments of the present invention, it may be possible to prevent the collision with the front vehicle and the rear-side vehicle by braking a vehicle in the braking avoidance section when there is the possibility of a collision and imposing a vehicle steering right to a driver in the steering avoidance section hen there is no the possibility of a collision, based on the collision with the rear-side vehicle according to steering in the steering avoidance section, which is predicted in the braking avoidance section.

The present invention described above may be variously substituted, altered, and modified by those skilled in the art to which the present invention pertains without departing from the scope and sprit of the present invention. Therefore, the present invention is not limited to the above-mentioned exemplary embodiments and the accompanying drawings.

What is claimed is:

1. An apparatus for preventing collision with a vehicle, comprising:
a controller includes a memory and a processor, the memory configured to store program instructions and the processor configured to execute the program instructions, the program instructions when executed configured to:
collect information required to calculate time-to-collision (ITC), a braking avoidance section, and a steering avoidance section;
calculate the braking avoidance section in which the collision with a front vehicle is avoided by braking;
calculate the steering avoidance section in which the collision with a front vehicle is avoided by steering;
calculate TTC with a rear-side vehicle when a traveling vehicle enters the b avoidance section;
generate a braking signal when the calculated TTC satisfies a threshold value; and
brake the traveling vehicle based on the braking signal.

2. The apparatus of claim 1, wherein the controller is further configured to generate the braking signal when a vehicle is present at both of a rear left and a rear right of the traveling vehicle.

3. The apparatus of claim 1, wherein the controller is configured to not generate the braking signal when a vehicle is present at one of the rear left and the rear right of the traveling vehicle and provide information regarding a lane in which a vehicle is not present to a driver.

4. The apparatus of claim 3, wherein the controller is further configured to impose a vehicle steering right of the traveling vehicle to a driver in the steering avoidance section.

5. The apparatus of claim 1, wherein the controller is further configured to calculate the TTC with a rear-side vehicle before the traveling vehicle enters the braking avoidance section to monitor the rear-side vehicle.

6. The apparatus of claim I, wherein the controller is further configured to calculate the TTC by dividing a distance from the mar-side vehicle and by a relative velocity to the rear-side vehicle.

7. The apparatus of claim 1, wherein the controller is further configured to calculate the braking avoidance section by adding a buffer distance to a threshold braking distance d_{brake} calculated by the following Equation A.
$${d}_{brake} = - \frac{{v}_{rel}^{2}}{2 {a}_{x}} \qquad Equation A$$
wherein, vᵣₑₗ represents a relative velocity to a front vehicle and aₓ represents a longitudinal velocity.

8. The apparatus of claim 1, wherein the controller is further configured to calculate the steering avoidance section by adding a buffer distance to a threshold steering distance dₛₜₑₑᵣ calculated by the following Equation B.
$${d}_{steer} = - {v}_{rel} \sqrt{\frac{2 {s}_{y}}{{a}_{y}}} \qquad Equation B$$
wherein, vᵣₑₗ represents a relative velocity to the front vehicle, s_{y} represents a quantity overlapping with the front vehicle, and a_{y} represents lateral acceleration.

9. The apparatus of claim 1, wherein the controller is further configured to collect information required to calculate the braking avoidance section, information required to calculate the steering avoidance section, and information required to calculate the TTC with the rear-side vehicle via a vehicle communication network.

10. The apparatus of claim 9, wherein the vehicle communication network includes at least one of a controller area network (CAN), a local interconnect network (LIN), FlexRay, and a media oriented system transport (MOST).

11. A method for preventing collision with a vehicle, comprising:
collecting, by a controller, information required to calculate time-to-collision (TTC), a braking avoidance section, and a steering avoidance section;
calculating, by the controller, the braking avoidance section in which the collision with a front vehicle is avoided by braking;
calculating, by the controller, the steering avoidance section in which the collision with a front vehicle is avoided by steering;
calculating, by the controller, TTC with a rear-side vehicle when a traveling vehicle enters the braking avoidance section;
generating, by the controller, a braking signal when the calculated TTC satisfies a threshold value; and
braking, by the controller, the traveling vehicle based on the braking signal.

12. The apparatus of claim 11, further comprising:
when the calculated TTC does not satisfy a threshold value, preventing, by the controller, the traveling vehicle from braking; and
imposing, by the controller, a vehicle steering right of the traveling vehicle to a driver when the traveling vehicle enters the steering avoidance section.

13. A non-transitory computer readable medium containing program instructions executed by a controller, the computer readable medium comprising:
program instructions that collect information required to calculate time-to-collision (TTC), braking avoidance section, and a steering avoidance section;
program instructions that calculate the braking avoidance section in which the collision with a front vehicle is avoided by braking;
program instructions that calculate the steering avoidance section in which the collision with a front vehicle is avoided by steering;
program instructions that calculate TTC with a rear-side vehicle when a traveling vehicle enters the braking avoidance section;
program instructions that generate a braking signal when the calculated TTC satisfies a threshold value; and
program instructions that brake the traveling vehicle based on the braking signal.

14. The non-transitory computer readable medium of claim 13, further comprising:
program instructions that prevent the traveling vehicle from braking when the calculated TTC does not satisfy a threshold value; and
program instructions that impose a vehicle steering right of the traveling vehicle to a driver when the traveling vehicle enters the steering avoidance section.
